(19) United States
(12) Patent Application Publication
(10) Pub. No.: US 2019/0087814 A1
(43) Pub. Date: Mar. 21, 2019

(54) METHOD FOR SECURING A PAYMENT TOKEN

(71) Applicants: IDEMIA FRANCE, Colombes (FR); OBERTHUR TECHNOLOGIES OF AMERICA CORP., Wilmington, DE (US)

(72) Inventors: Eric LASSOUAOUI, Colombes (FR); Philippe LEDRU, Colombes (FR); Francis LIMOUSY, Colombes (FR)

(21) Appl. No.: 15/526,813

(22) PCT Filed: Nov. 16, 2015
(86) PCT No.: PCT/FR2015/053079

§ 371 Date: May 15, 2017

(30) Foreign Application Priority Data
Nov. 17, 2014 (FR) 1461087

(51) Int. Cl. G06Q 20/36; G06Q 20/40; H04L 29/06

(52) U.S. Cl. CPC G06Q 20/3674; G06Q 2220/00; H04L 63/0428; G06Q 20/401

(57) ABSTRACT

This application describes systems and methods for securing a payment token, to a mobile terminal, and to a server for generating a payment token. The operations performed by the systems and methods include a prior step of pairing a payment instrument both to an identifier of a subscriber terminal and to a personal password, followed by a step of generating a payment token that is made secure by using the identifier and the personal password. The pairing and the generating of the secure payment token make it possible to verify that the token is used by that subscriber and by that subscriber's mobile terminal. The systems and methods may be used in payment systems based on payment tokens that have usage restrictions.

The field of the invention relates to a method of securing a payment token derived from a payment instrument, a mobile terminal, and a server for generating a payment token.

Payment card frauds still exist in spite of the sophistication with which bank data is made secure, and in spite of the measures implemented for verifying a transaction over the payment network. A payment card is protected by verifying a personal code stored in an electronic chip, and also by using dynamic algorithms for verifying the data of the bank transaction.

With the development of the digital economy, the share of transactions taking place over the Internet is increasing daily. A new trend is also providing a virtual payment card that is hosted on a mobile payment application of a mobile telephone. A subscriber thus possesses a dematerialised version of a bankcard that he can use for making a near field payment using near field communication (NFC) technology.

This new economy presents an opportunity for banking organizations, but it also presents non-negligible risks of fraud because of the exposure of bank data, and in particular the bankcard number, the security cryptogram, and the expiry date of the card. People hostile to near field payment technology are particularly concerned about the vulnerability of bank data during near field communication, since the data is transmitted without being encrypted. In particular, devices exist that are capable of intercepting data being used during a transaction.

Furthermore, it is not uncommon for hackers to steal bank data from an online merchant's server.

In response to such bank frauds, banking organizations are looking for solutions to avoid exposing the bank data of a bankcard subscriber. Nowadays, there exist systems for hosting bank data on secure bank servers and solutions for generating restrictive payment tokens that are derived from a subscriber's payment card. Such tokens are restrictive in the sense that they can include usage restrictions, for example they may be valid for a limited period, with only a single trader, or they may be capped by a maximum transaction amount. Such payment solutions are referred to as host card emulation (HCE). In the event of the token data being stolen, financial exposure is reduced.

An HCE architecture requires a server for generating tokens that are derived from a bankcard by diversification algorithms, remote servers for providing tokens on a bank application hosted on the operating environment of a portable terminal (e.g. a cell phone or a tablet), and a token verification server that is capable of determining the bank data of a subscriber corresponding to the payment token.

In this architecture, a bankcard subscriber may possess a bankcard in various forms, a physical card with an electronic chip or a magnetic stripe, a virtual card hosted in an electronic wallet on a mobile telephone (commonly referred to as a “mobile wallet”), or a virtual card hosted on a remote server (commonly referred to as a “cloud wallet”). American patent application US 2013/0200146 A1 discloses a solution for hosting a virtual bankcard on a remote server.

Nevertheless, even though a payment token possesses restrictions on utilisation, it remains exposed to theft between the moment when it is provisioned on a mobile telephone and the moment when it is used. Specifically, a subscriber may cause a telephone to be provisioned with a batch of tokens for multiple payments.

Furthermore, telephone manufacturers and banking organizations would like to provide electronic wallets on mobile telephones without being subject to the constraints of a secure chip, and to propose a software-only payment solution. Such a solution is particularly exposed to data theft.

There therefore exists a need to find new measures for securing payment tokens on a mobile telephone, in particular when the tokens are not hosted in a secure chip.

More precisely, the invention provides a method of securing a first token derived from a subscriber's payment instrument, which instrument may be hosted in a mobile terminal by a payment application.

According to the invention, the method comprises the following successive steps:
pairing firstly an identifier of the mobile terminal with the payment instrument, and secondly a personal cryptogram with the payment instrument;
provisioning the first token to the payment application;
receiving data concerning a payment transaction by the payment application; and
generating a secure second payment token by encrypting at least the first token, the transaction data, the identifier of the terminal, and the personal cryptogram.

More precisely, the pairing is performed following a successful authentication protocol between the payment application and a remote authentication server.

In a variant, the pairing is performed when the payment instrument is registered in the payment application.

In a variant, the first token is random data derived from data representing the bank account number attached to the payment instrument.

In a variant, the first token is encrypted by means of a temporary key received from a server for generating the first token.

In a variant, the method further comprises the payment application generating the identifier of the terminal and the personal cryptogram, with generation being triggered by receiving data concerning the transaction.

In a variant, the payment application generating the identifier of the terminal and the personal cryptogram comprises reading a secure memory of the terminal on condition that a personal password is input, or in another variant executing a cryptographic calculation on condition that a personal password is input.

In a variant, generation of the identifier of the terminal and of the personal cryptogram by the payment application is triggered by a request to authenticate the subscriber during the payment transaction, the payment transaction being a contactless payment transaction in compliance with the ISO/IEC 14443 standard.

Preferably, during execution of the bank transaction, the identifier and the personal cryptogram are stored in a volatile memory of the terminal.

Provision is made for the provisioning of the first token to comprise writing the first token in a nonvolatile memory of the terminal.

The invention also provides a mobile terminal including a payment application comprising a treatment agent for treating a first token derived from a subscriber's payment instrument, and means for receiving data concerning a payment transaction. The payment application further includes:
pairing means for pairing an identifier of the mobile terminal and a personal cryptogram with the payment instrument;
and the treatment agent for treating the token includes means for generating a secure second payment token by encrypting at least the token, the transaction data, the identifier of the mobile terminal, and the personal cryptogram.

In a variant, the payment application further includes means for generating the identifier of the mobile terminal and the personal cryptogram by the payment application.

The invention also provides a server for generating a first token, the server comprising means for generating a first token derived from a payment instrument of a subscriber, the server being characterized in that it further comprises:
means for pairing an identifier of the mobile terminal and a personal cryptogram of the subscriber with the payment instrument;
means for verifying the secure second payment token generated by encrypting at least the first token, the transaction data, the identifier of the mobile terminal, and the personal cryptogram.

In a variant, the identifier of the mobile terminal and the personal cryptogram of the subscriber are received from an authentication server.

In a variant, the first token is generated by means of a random number generator as a function at least of data representing the number of the bank account attached to the payment instrument.

By means of the invention, the use of the payment token is made secure by prior pairing with the user, via a personal cryptogram, and with the user's mobile terminal, registered by a unique identifier. Integrating identification data both for the terminal and also for the user enables the bank transaction verification server to verify that the token has been used by the registered terminal and the registered user.

Other characteristics and advantages of the present invention appear more clearly on reading the following detailed description of embodiments of the invention given as nonlimiting examples and illustrated by the accompanying drawings, in which:

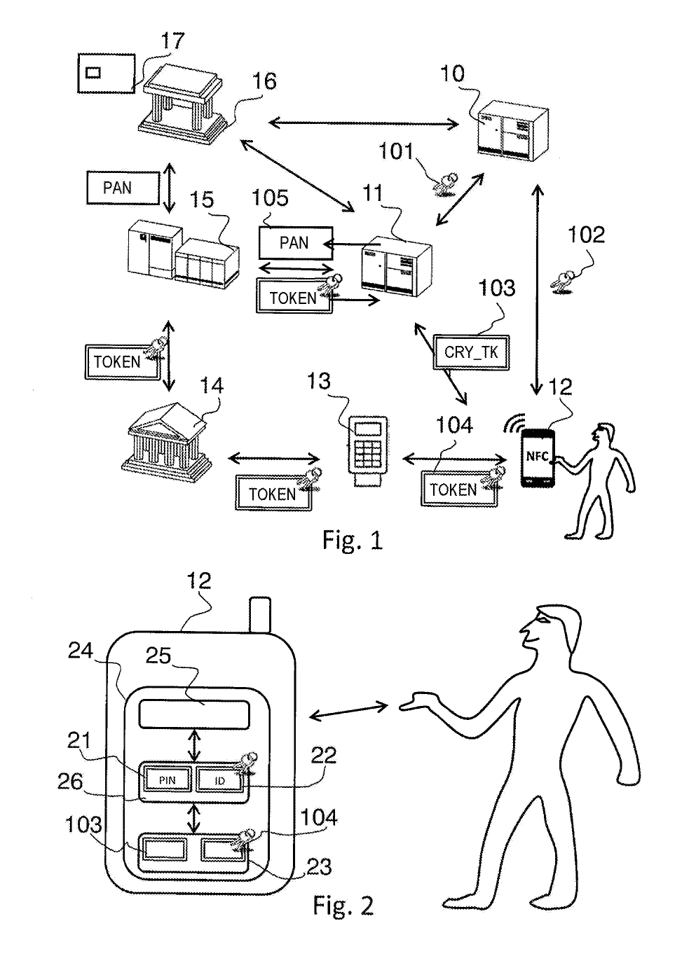

FIG. 1 shows the ecosystem of an HCE type payment architecture;

FIG. 2 shows the software operating environment of a mobile telephone for hosting and generating a secure payment token;

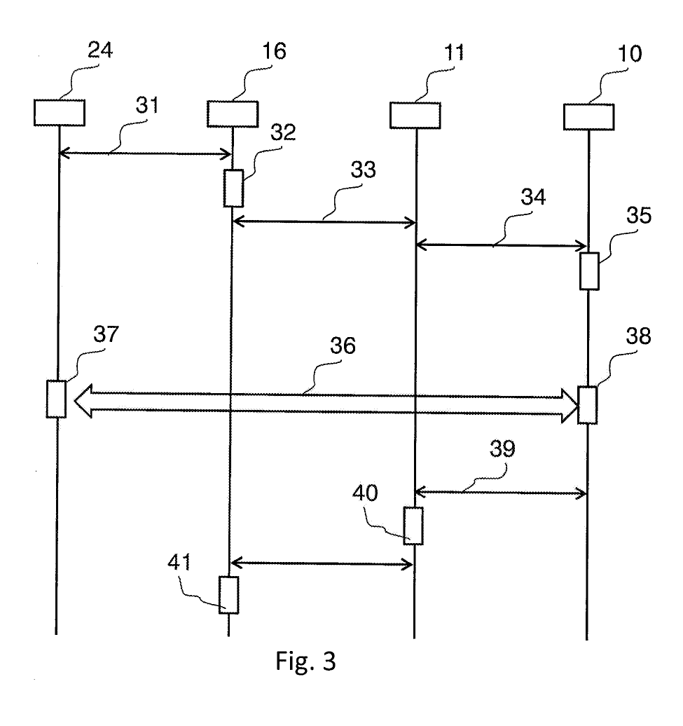

FIG. 3 shows a sequence stream for pairing a user and a mobile terminal prior to provisioning and generating a payment token for the subscriber;

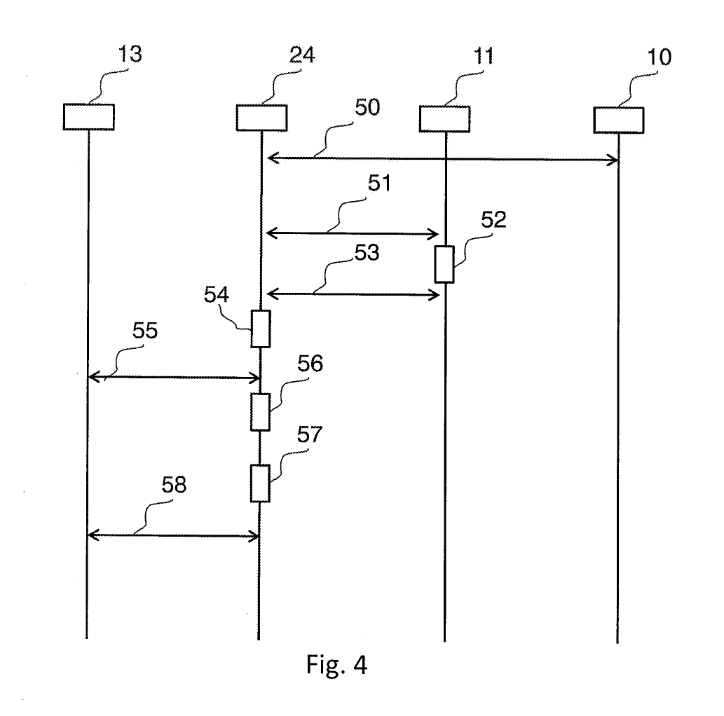

FIG. 4 shows a sequence stream while executing a bank transaction and generating a secure payment token.

The invention applies in the context of a payment system provisioning secure payment tokens to a subscriber of a payment instrument. The payment system is commonly referred to by the acronym HCE.

FIG. 1 shows the ecosystem of an HCE payment solution. It provides a banking entity 16, a bank or a payment service, capable of issuing a payment instrument 17. The payment instrument 17 may comprise a plurality of payment products in the form either of a bank card, or of an online payment service via an Internet portal, or a payment service by means of payment tokens that can be provisioned to a mobile terminal 12 of the subscriber.

The payment instrument 17 is defined:
by the subscriber's bank data, such as an account number associated with the payment instrument and personal data;
by criteria for using the payment instrument, in particular a period of validity, a geographical area, a transaction ceiling; and
security data, such as for example the security cryptogram or electronic security mechanisms incorporated in a payment card enabling the data of a bank transaction to be verified.

For a mobile terminal 12 that is to receive payment tokens, the security mechanisms may be hosted in a secure module soldered in the terminal, e.g. an integrated circuit of the NFC type, or they may be hosted in a secure environment known as a trusted execution environment (TEE). With such an environment, the solution is entirely of the software type in which the application zone of the operating environment of the mobile terminal executing a payment application is considered as being trustworthy by various security mechanisms. Those mechanisms may be verifying the memory zone, or authentication protocols for use with a remote authentication server 10 for installing payment profiles or applications. The functions of the mobile terminal 12 capable of generating the secure payment token 104 used in the context of the invention are described in greater detail below.

Preferably, the mobile terminal 12 has communications means for receiving and sending data remotely, either via the cellular telephone network, or over an IP type data network via the telephone network, or over an IP type data network via a medium-range network, e.g. Wi-Fi.

In the context of the invention, provision is made for an authentication server 10 that is managed either by the banking organization 16 or by a third party provider of authentication services. The authentication server 10 exchanges cryptographic means 102 with the mobile terminal 12. By way of example, these cryptographic means 102 are cryptographic session keys, temporary transaction numbers, or cryptographic algorithms making it possible to operate a secure exchange protocol. These cryptographic means are exchanged via a secure channel that may use a hypertext transfer protocol secure (HTTPS), a card application toolkit transport protocol (CAT_TP), or a short message service (SMS).

Furthermore, the authentication server 10 may exchange information with the bank entity 16 via a secure network for remotely communicating data wirelessly or via a wired communications network if the authentication server 10 is operated by the banking entity 16. Thus, the banking entity 16 can transmit personal and bank data of a subscriber to the authentication server 10 for the needs of authentication protocols between the subscriber's mobile terminal 12 and the authentication server.

A token-generator server 11 is also provided for generating tokens 103 derived from the payment instrument 17. The server 11 has cryptographic means for generating a token 103 from bank data 105 attached to the payment instrument 17.

A random data generator can generate a token 103 from bank data 105 and from diversification or derivation means, e.g. a counter. Other diversification means may be used for generating the token 103 in the server 11.

It should be observed that provision is made for the bank data 105 used by the random data generator to be recoverable by the token-generator server 11 or by a partner verification server on the basis of the information in the secure payment token 104. The bank data is thus protected and kept secret in the server 11.

Furthermore, the server 11 for generating the token 103 may exchange information with the banking entity 16 via a secure network for remotely communicating data wirelessly or via a wired communications network, if the authentication server 11 is operated by the banking entity 16. Thus, the banking entity 16 can transmit personal and bank data of a subscriber to the authentication server 10 for the needs of authentication protocols between the subscriber's mobile terminal 12 and the authentication server.

Furthermore, the token-generator server 11 can exchange information with the authentication server 10 via a secure network for communicating data remotely wirelessly or else via a wired communications network if the servers 10 and 11 are managed by the same operator. The authentication server 10 exchanges cryptographic means 101 with the server 11 for generating tokens 103. By way of example, these cryptographic means 101 are cryptographic session keys, temporary transaction numbers, or cryptographic algorithms making it possible to operate a secure exchange protocol with the terminal 12.

In particular, the secure exchange protocol with the terminal 12 makes it possible to exchange tokens 103 via a secure channel that may use an HTTPS, a CAT_TP or an SMS protocol.

A secure payment network 15 may be provided for transmitting subscriber bank data and bank transaction data in compliance with the specifications of the Europay, MasterCard, Visa (registered trademarks) (EMV) standards, e.g. the conventional transaction data and the secure payment tokens. The secure payment network 15 is operated by a payment service operator 14 in charge of operating bank payment transactions.

The payment service operator uses the secure network 15 for transmitting the transaction data received from merchant 13, by means of a payment terminal or a remote payment server. The network 15 uses a secure wireless or wired communications network between the payment terminals.

FIG. 2 shows a terminal 12 in greater detail. It has a payment application 24 hosted in the operating environment of the mobile terminal 12 or in a secure module, e.g. an embedded universal integrated circuit card (eUICC).

The mobile terminal 12 as nonvolatile memories of the read only memory (ROM), electrically erasable read only memory (EEPROM), or flash type for storing parameters and execution code of applications and the computer program having the instructions for performing the method of securing payment tokens, e.g. the operating environment of the terminal, applications, or libraries of specific functions suitable for use by the applications.

In particular, the terminal has libraries of functions, classes, or methods, referred to as the application programming interface (API), for performing the exchanges with the token-generator server 11, for executing payment transactions with a payment terminal 13, and for authentication with the authentication server 10. The application 24 may call on the functions provided by the APIs.

The mobile terminal also has random access memory (RAM) for storing temporary parameters, e.g. bank transaction data or a secure payment token 104. The RAM includes registers adapted to store parameters and variables created during execution of the computer program having the instructions for performing the method of securing payment tokens while it is being executed.

The terminal 12 also has man machine interfaces for use with the subscriber to input and display data, e.g. for inputting a personal identification number (PIN) and for interacting with the payment application 24. Provision is made for the payment application to display requests on a screen of the mobile terminal, e.g. a request to move the terminal 12 close to the payment terminal 13, a request to input a personal code, or a request to select a payment instrument.

The mobile terminal includes the processor for executing the functions of the applications of the mobile terminal 12.

The payment application 24 has a treatment agent 23 for treating a token 103 derived from a payment instrument 17 of a subscriber, and means 25 for receiving data concerning a payment transaction. The treatment agent 23 is a function of the payment application 24 enabling the token 103 sent by the token-generator server 11 to be received and to be stored in a nonvolatile memory of the mobile terminal. The treatment agent 23 is a software application making use of the API software functions for interaction with the server 11 that generates the token 103.

Furthermore, the payment application 24 hosts one or more payment instruments 17. A virtual payment card is stored in the form of an application specific to the profile of the payment card, and it may be stored by means of an application identifier. The payment instrument is stored in the payment application before the first provisioning of a payment token.

The means 25 for receiving bank transaction data is a function of the payment application 24 enabling communication with the payment terminal 13. The receive function is capable of operating a contactless exchange protocol in compliance with the ISO/IEC 14443 standard, of storing the data concerning the transaction in a memory, and of returning responses to the payment terminal 13.

Also, the payment application 24 includes pairing means 26 for pairing both an identifier of the mobile terminal 22 and also a personal cryptogram 21 with the payment instrument. It is a function calling on API software functions for authentication with the authentication server 10 and the token-generator server 11. Pairing includes in particular means for generating the identifier 22 allocated to the terminal 12 and the personal cryptogram 21 allocated to the subscriber.

The identifier of the terminal 22 can be generated by the authentication server 10 and can be transmitted to the terminal 12 in order to be stored in secure manner, e.g. encrypted using a key. In another variant, the identifier 22 may be the international mobile equipment identity (IMEI) number of the terminal 12, and it may be transmitted to the authentication server 10. It may be transmitted by the terminal 12 during pairing or by the banking entity 16.

The personal cryptogram 21 may be a password, a personal code, or a digital biometric print known by the subscriber and by the authentication server. The personal cryptogram may also be generated by a function after successful authentication using a PIN or biometric authentication. In a variant, the personal cryptogram 21 may be generated from a random number known only by the terminal 12 and by the authentication server, or by an encryption key. Known methods referred to as “salting” also serve to generate the personal cryptogram 21, both by the payment application 24 and by the authentication server 10.

Pairing is effective when the payment application 24 has linked a payment instrument 17 with the identifier 22 of the terminal and the personal cryptogram 21. Likewise, the generator server 11 links the identifier 22 and the cryptogram 21 with the payment instrument 17. The identifier 22 of the terminal 12 and the personal cryptogram 21 enabling pairing in the server 11 are transmitted by the authentication server 10 that has previously successfully performed the authentication protocol with the terminal 12 and the subscriber.

Pairing is preferably performed when registering the payment instrument 17 in the mobile terminal. Registration corresponds to installing a digital payment profile in the nonvolatile memory of the mobile terminal 12.

The pairing of the terminal is made secure by the authentication with the authentication server 10.

Also, the agent 23 for treating a token 103 comprises means for generating a secure payment token 104 by encrypting at least the token 103, the transaction data, the identifier 22 of the mobile terminal, and the personal cryptogram 21. Both the encryption and obtaining the secure payment token 104 are performed by using a token encryption key and an encryption algorithm of the keyed-hash message authentication code (HMAC) type, for example in compliance with the recommendations of the initiative for open authentication (OATH). The encryption algorithm makes mutual authentication possible with the token-generator server 11. The encryption key is transmitted to the payment application 24 by the token-generator server 11. While it is not in use, the key is stored in a secure zone of the mobile terminal, optionally in encrypted form. The encryption key may be temporary. It may be associated with a single payment token 103, with a batch of payment tokens 103, or it may be limited in time.

More precisely, the data of the token 103, the transaction data concerning the payment terminal 13 (transaction amount, transaction number), the identifier 22 of the terminal, and the personal cryptogram 21 are concatenated in a data block (possibly having a length of 128 bits). This concatenated data is then encrypted by the encryption algorithm using the encryption key. The secure payment token 104 generated by the payment application 24 is in the form of a cryptogram accompanying a request for verifying a bank transaction that comprises at least the transaction data.

It should be observed that the secure payment token 104 may be generated in off-line mode, i.e. a connection with the server 11 for generating the token 103 is not necessary during the transaction.

Furthermore, the treatment agent 23 includes means for inserting the secure payment token 104 in a conventional bank transaction protocol. By way of example, it may be inserted in a standardised data field in the EMV transaction protocols.

Thus, the secure payment token 104 may be transmitted by a payment terminal without modifying its communication protocol with the payment network 15.

The server 11 for generating a token 103 includes means for generating a token derived from the payment instrument 17. The derived token is random data. The token 103 is generated from the bank data 105 of the payment instrument 17 (associated account number) and a diversifier. The diversifier represents authorization for a payment transaction with usage restriction criteria determined by the server 11, e.g. validity for one or more bank transactions, validity for a length of time, validity with a transaction ceiling.

In the context of the invention, the server 11 also includes means for pairing the identifier of the mobile terminal 22 and the personal cryptogram 21 of the subscriber with the payment instrument 17. In its bank databases, it includes in particular: the bank data 105 associated with the payment instrument 17 (associated account number); and the identifier 22 of the terminal 12 and the personal cryptogram 21 of the subscriber that are allocated to the payment instrument 17.

Also, it includes means for verifying the secure payment token 104 generated by encrypting at least the token 103, the transaction data, the identifier 22 of the mobile terminal, and the personal cryptogram 21. In particular, it includes cryptographic means complementary to those of the payment application 24 in order to generate a second payment token for verification purposes, as a function of the transaction data as transmitted by the request for verifying a bank transaction. The verification means comprise means for generating a verification cryptogram by encrypting at least the token 103, the transaction data, the identifier 22 of the mobile terminal, and the personal cryptogram 21. Comparing the secure payment token 104 with the verification cryptogram makes it possible to authorize or not authorize the transaction.

It should be observed that the identifier of the mobile terminal 22 and the personal cryptogram 21 of the subscriber are received from the authentication server 10 or may be generated dynamically on receiving the secure payment token 104 in order to verify the bank transaction.

FIG. 3 shows a stream of sequences of steps for pairing a payment instrument with an identifier 22 of the terminal 12 and a personal cryptogram 21. The pairing is performed while registering the payment instrument 17 in the payment application 24 of the subscriber's terminal 12.

At a registration request step 31, the subscriber uses its payment application 24 to register for using the payment instrument 17. The registration request is transmitted to the bank entity 16 operating the payment instrument.

In a variant, the registration request step 31 may be performed via a web portal, or directly at a branch of the banking entity.

The banking entity 16 initiates a registration request in a step 32. During the step 32, identifiers and a personal password for single use can be generated and transmitted to the subscriber in order to initiate authentication with the authentication server 10. In parallel, the identifiers and the password are communicated to the server 11 for generating a payment token during a step 33, and then to the authentication server 10 during a step 34.

During the step 33, the banking entity 16 also transmits the banking data of the payment instrument 17 enabling a payment to be made (bank account number and restriction criteria, in particular).

During the step 35, the authentication server 10 begins an authentication protocol, waiting to receive a pairing request from the user's payment application 24. Sets of encryption keys and authentication transaction identifiers are prepared to enable secure transmission of a terminal identifier and a personal cryptogram between the payment application and the authentication server.

During a step 37, the payment application 24 initiates a pairing request and executes the decryption and encryption operations needed for making requests and responses during the authentication protocol 36.

In parallel, in a step 38, the authentication server 10 executes the complementary operations for carrying out the authentication protocol for the pairing 36 between an identifier of the mobile terminal and the payment instrument and a personal cryptogram of the subscriber and the payment instrument.

In a variant, the authentication protocol may be initiated by the authentication server calling the payment application 24.

During the authentication protocol corresponding to executing the pairing 36, the identifier 22 of the terminal 12 and the personal cryptogram 21 are generated, either by the server 10, or else by the payment application 24, and they are mutually exchanged.

It should be observed that the pairing 36 comprises storing of the identifier 22 of the terminal and the personal cryptogram 21 in the authentication server 10 or storing calculation functions for generating the identifier 22 of the terminal and the personal cryptogram 21 in the authentication server 10.

In a variant, the identifier 22 of the terminal and the personal cryptogram 21 are generated dynamically during each bank transaction. The payment application 24 and the server 10 have generator means that are exchanged during the authentication stage 36. This may be a specific authentication application and the cryptographic algorithms. These means for generating the identifier 22 and the personal cryptogram 21 may also be obtained via an application portal or they may already be installed with the payment application 24.

The payment application 24 is installed via a secure installation protocol comprising installing a profile of a bank application in a secure NFC module for operating bank transactions in compliance with the ISO/IEC 14443 standard.

Once the authentication protocol for the pairing operation 36 has terminated successfully, the authentication server 10 acts in a step 39 to inform the server 11 for generating the payment token 103 of the identifier 22 of the terminal and of the personal cryptogram 21 as part of the cryptographic means 101. This is for the purposes of verifying payment transactions using the payment tokens.

In a step 40, the server 11 installs the identifier 22 of the terminal and the personal cryptogram 21 or the generator means associated with the subscriber's payment instrument 17.

In a step 41, the banking entity 16 is informed of the success of the authentication and of the pairing for the operation of the payment solution by means of the secure payment token.

FIG. 4 shows a stream of sequences while generating a secure payment token 104 during a bank transaction.

In a first step 50, the payment application 24 makes a request to be provisioned with a token. A step of authenticating the subscriber is performed by the authentication server 10. By verifying an identifier and a personal password, or in a variant by means of the identifier 22 of the terminal 12 and the personal cryptogram 21 generated during the pairing step.

If authentication with the authentication server 10 is successful, the application 24 performs a step 51 of requesting provisioning of a token 103 from the token-generator server 11. The provisioning request is performed via a secure communications channel between the payment application 24 and the server 11, e.g. using an HTTPS, a CAT_TP, or an SMS communications protocol.

During a step 52, the token-generator server 11 generates a first token 103 derived from the payment instrument 17. The token 103 is random data derived from data 105 representing the bank account number attached to the payment instrument 17. This data may be the bank account number. The token 103 is random data defined by use restriction criteria, e.g. a number of bank transactions, a validity duration, or an amount for the transaction. It is preferable to use a random number generator operating as a function at least of the data 105 representing the bank account number attached to the payment instrument 17. A counter providing input data to the generator serves to diversify the data 105.

In a step 53, the server 11 transmits the token 103 to the payment application 24 via the same secure channel as was used during the step 51.

In a step 54, the payment application 24 stores the token 103 in a (nonvolatile) secure memory zone of the mobile terminal 12. The treatment agent 23 stores the token 103 in a memory zone to which access is conditional on authentication with the authentication server 10. In a variant, the token 103 is transmitted in encrypted form waiting for use by means of a key provided by the server 11.

During a step 55, a bank transaction protocol is initiated with a payment terminal 13. The application 24 receives transaction requests and issues responses to these requests. The transaction performed is a contactless near field (NFC) payment transaction, e.g. in compliance with the ISO/IEC 14443 standard. During a first exchange, transaction data may be transmitted, e.g. a transaction amount.

In a step 56, the payment application 24 proceeds to generate the identifier 22 of the terminal and the personal cryptogram 21. This generation may be a reading in a secure memory of the terminal 12, or the generation of data by cryptographic calculation, e.g. decryption or encryption. Generation 56 is preferably conditional on inputting and verifying a personal password (PIN, phrase, reading biometric data such as a fingerprint or scanning the iris).

During generation 56, the identifier 22 and the cryptogram 21 may be stored in a volatile memory of the terminal 12 while the bank transaction is being executed. After the bank transaction has been performed, they are subsequently deleted so as not to be exposed to potential fraud.

It should be observed that generation 56 of the identifier 22 of the terminal and of the personal cryptogram 21 may be triggered by a request to authenticate the subscriber during a contactless payment transaction, in compliance with the ISO/IEC 14443 standard.

In a step 57, the payment application 24 generates a secure second payment token 104. The payment application 24 encrypts at least the first token 103, the transaction data, the identifier 22 of the terminal, and the personal cryptogram 21. The application 24 uses the encryption algorithm of the token treatment agent 23 in order to generate the secure payment token 104. A consequence of the encryption algorithm is to make the secure payment token 104 unique per terminal 12 and unique per subscriber.

If the payment token 104 is used by another terminal, that has not been registered during the prior pairing and that is not capable of reproducing the identifier 22 of the terminal, then the server 11 for verifying the secure payment token 104 can detect this situation and can refuse the bank transaction.

Likewise, if the payment token 104 is used by another subscriber, who has not been registered during the prior pairing and who is not capable of reproducing the personal cryptogram 21, then the server 11 for verifying the secure payment token 104 can detect this situation and can refuse the bank transaction.

Optionally, the format of the secure payment token 104 may be modified, e.g. using a hashing function, for subsequent insertion in a data field in compliance with a bank transaction.

Thereafter, during a step 58, the secure payment token 104 is transmitted to the payment terminal 13 during execution of the bank transaction. It is transmitted in the near field via the NFC communication means together with data of the bank transaction, as is conventionally done in the EMV standard.

Thereafter, the payment terminal 13 uses the payment network 15 to transmit the secure payment token 104 to the server 11 for generating the payment token 103 for the purposes of verifying the transaction. The verification server 11 may be distinct from the server 11 that generated the token.

Provision may be made for a given subscriber to carry out pairing with a second mobile terminal, e.g. a multimedia tablet if the first mobile terminal is a cellular telephone. During pairing with the second mobile terminal, provision is made for the server 10 to associate the second terminal with the payment instrument 17, using a second terminal identifier. The personal cryptogram 21 may be identical.

When the verification server receives the secure payment token 104, it performs the same cryptographic calculation as the treatment agent 23 of the payment application 24. Once validated, the authorization order is transmitted together with the bank data 105 of the instrument 17 associated with the token 103 to the banking entity 16 via the payment network 15.

It should be observed that the first token 103, transmitted by the server 11 to the terminal 12 may be used for a plurality of payment transactions. Its use may be restricted to a determined duration, some number of payment transactions, or a transaction amount, which may be constituted by the sum of a plurality of payment transactions.

1. A method of securing a first token derived from a subscriber's payment instrument, which instrument may be hosted in a mobile terminal by a payment application, wherein the method comprises:
pairing firstly an identifier of the mobile terminal with the payment instrument, and secondly a personal cryptogram with the payment instrument;
provisioning the first token to the payment application;
receiving transaction data concerning a payment transaction by the payment application; and
generating a secure second payment token by encrypting at least the first token, the transaction data, the identifier of the mobile terminal, and the personal cryptogram.

2. The method according to claim 1, wherein the pairing is performed following a successful authentication protocol between the payment application and a remote authentication server.

3. The method according to claim 2, wherein the pairing is performed when the payment instrument is registered in the payment application.

4. The method according to claim 1, wherein the first token is random data derived from data representing a bank account number attached to the payment instrument.

5. The method according to claim 1, wherein the first token is encrypted by means of a temporary key received from a server for generating the first token.

6. The method according to claim 1, it wherein the method further comprises the payment application generating the identifier of the mobile terminal and the personal cryptogram, wherein the generating is triggered by receiving data concerning the payment transaction.

7. The method according to claim 6, wherein the payment application generating the identifier of the mobile terminal and the personal cryptogram comprises: reading a secure memory of the mobile terminal on condition that a personal password is input, or executing a cryptographic calculation on condition that a personal password is input.

8. The method according to claim 6, wherein generating the identifier of the mobile terminal and the personal cryptogram is triggered by a request to authenticate the subscriber during the payment transaction, the payment transaction being a contactless payment transaction in compliance with the ISO/IEC 14443 standard.

9. The method according to claim 6, wherein, during execution of the payment transaction, the identifier and the personal cryptogram are stored in a volatile memory of the mobile terminal.

10. The method according to claim 1, wherein the provisioning comprises writing the first token in a nonvolatile memory of the mobile terminal.

11. A mobile terminal including a payment application comprising:
a treatment agent for treating a first token derived from a subscriber's payment instrument;
means for receiving transaction data concerning a payment transaction; and
pairing means for pairing an identifier of the mobile terminal and a personal cryptogram with the payment instrument;
wherein the treatment agent for treating the first token includes:
means for generating a secure second payment token by encrypting at least the first token, the transaction data, the identifier of the mobile terminal, and the personal cryptogram.

12. The mobile terminal according to claim 11, further wherein the payment application further comprises means for generating the identifier of the mobile terminal and the personal cryptogram application.

13. A server for generating a first token, the server comprising:
means for generating the first token derived from a payment instrument of a subscriber;
means for pairing an identifier of a mobile terminal and a personal cryptogram of the subscriber with the payment instrument;
means for verifying a secure second payment token generated by encrypting at least the first token transaction data, the identifier of the mobile terminal, and the personal cryptogram.

14. The server according to claim 13, wherein the identifier of the mobile terminal and the personal cryptogram of the subscriber are received from an authentication server.

15. The server according to claim 13, wherein the first token is generated using a random number generator as a function at least of data representing a number of a bank account attached to the payment instrument.
